(19) United States
(12) Patent Application Publication
(10) Pub. No.: US 2024/0337333 A1
(43) Pub. Date: Oct. 10, 2024

(54) COMPOSITE TUBULAR STRUCTURE

(71) Applicant: COMPOSITE BRAIDING LTD, Nottingham (GB)

(72) Inventors: Alastair Edward BARNETT, Nottingham Nottinghamshire (GB); Mark BENSON, Nottingham Nottinghamshire (GB); Samuel Peter DONEGANI, Nottingham Nottinghamshire (GB); Stephen Kennedy BARBOUR, Nottingham Nottinghamshire (GB)

(21) Appl. No.: 18/294,891

(22) PCT Filed: Aug. 2, 2022
(86) PCT No.: PCT/GB2022/052037

§ 371 Date: Feb. 2, 2024

(30) Foreign Application Priority Data
Aug. 3, 2021 (GB) 2111221.4

(51) Int. Cl. F16L 11/08; B29C 63/28; B29C 63/34; F16L 11/22

(52) U.S. Cl. CPC F16L 11/087; B29C 63/28; B29C 63/341; F16L 11/22

(57) ABSTRACT

A tubular structure (1) formed by a plurality of circumferentially continuous tubes (11, 12) of fibre reinforced plastics material. The structure (1) comprises an outer shell (14) and at least one internal web (15). The plurality of tubes (11, 12) are bonded together and comprise a plurality of inner tubes (12) located inside an outer tube (11) such that they form each of the outer shell (14) and the internal web (15) with a pair of laminated layers of fibre reinforced plastics material bonded to one another.

This invention relates generally to tubular structures. More specifically, although not exclusively, this invention relates to tubular structures formed of fibre reinforced plastics materials.

### BACKGROUND

It is known to use fibre reinforced plastics (FRP) materials to form tubular structures. Such structures may be formed using known FRP processing techniques, for example using pultrusion, autoclave moulding, wet layup, and automated fibre placement. It is also known to use FRP materials with thermoplastic matrices, to form tubular structures using extrusion and injection moulding processes.

FRP tubular structures are versatile due to the ability to select specific combinations of materials to provide desirable properties. For example, for lightweight structures which require a high modulus of elasticity, carbon fibres are often impregnated with a thermoset resin to produce the FRP structures. More economically, glass fibres may be used where it is permitted for specific modulus or specific strength to be less. This versatility means that FRP tubular structures have many known uses. For example FRP tubular structures may be used as structural members, e.g. for transporting fluids, or as conduits, e.g. for providing protection to cables.

FRP tubular structures are often required to withstand complex load profiles, including any combination of bending, axial or radial compression, axial or radial tension, and torsion. These loading profiles may be quasi-static or dynamic. The loading profiles may include impact loading, ballistic loading, or cyclic loading. The FRP structures may also be subject to loading profiles over prolonged periods of time, which could introduce creep or relaxation into the FRP structure. Any of the aforementioned loading conditions could lead to failure of the FRP tubular structure and so the FRP tubular structure may be required to prevent catastrophic failure by, for example, preventing or limiting crack propagation.

The FRP structures may also be required to withstanding environmental conditions, for example extreme temperatures, exposure to radiation, or exposure to chemicals. Any of these conditions may be applied to the inside and/or the outside of the FRP structure and may be alongside the aforementioned load profiles.

With such possible variation in uses, load profiles and environmental conditions, the versatility of FRP tubular structures is beneficial, and it is known to use different materials within a structure to tailor the structure for the specific applications in which it is used.

There are several known ways to design a tubular structure to optimise performance when subjected to mechanical loading and/or environmental conditions. It is known to align fibres in specific directions to provide greater stiffness and strength in those directions. For example, more fibres may be aligned circumferentially in a pipe which contains hydrostatic pressure, than axially, to increase the performance of the pipe in the hoop direction.

However, this is only beneficial where the structure is subjected to loads which are significantly greater in one direction than in other directions. It is also known to incorporate dissimilar reinforcement fibres into the FRP structure, to gain benefits from the properties of both types of reinforcement fibre. It is also known to use fillers within the matrices of the FRP materials, to improve specific mechanical properties, such as toughness. However, such designs often have diminishing returns, as manufacturing costs of using dissimilar reinforcement fibres, or of using fillers in resins, are significantly higher than manufacturing costs without these.

It is also known to improve the strength or stiffness of FRP tubular structures by increasing the thickness of FRP sections, for example by increasing the wall thickness of a tubular structure. The wall thickness is sometimes increased by bonding concentric tubes together. This means that different characteristics can be combined. For example, a liner may be used which is resistant to damage caused by a fluid transported by the structure, the liner also increasing the wall thickness of the structure to improve mechanical properties. However, increasing the thickness of sections also increases the weight of the structure, which is often contrary to the motivation for using FRP materials. It is also known to improve mechanical performance by incorporating cellular materials such as rigid foams into the FRP structures. In the case of tubular structures these cellular materials are often used to fill the FRP tube. This is especially beneficial to energy absorption characteristics but is often less beneficial for other mechanical performance due to the low modulus and strength of the foam relative to the FRP material. Furthermore, such filling of the FRP tubes prevents the use of the tubes as conduits.

### BRIEF SUMMARY OF THE DISCLOSURE

It would be advantageous to provide a composite tubular structure without some or all of these limitations.

According to an aspect of the invention, there is provided a tubular structure having an internal web comprising a fibre reinforced plastics material.

The tubular structure may comprise a shell, e.g. an outer shell. The internal web may extend from one portion of the shell to another portion of the shell. The internal web(s) may segment the tubular structure or shell. For example the internal web(s) may extend between and/or join opposite, e.g. diametrically opposite, sides of the shell.

The internal web(s) may be configured to improve the mechanical performance of the tubular structure. For example, the internal web may be configured to provide improvements to one or more of the bending performance; the axial, radial and hydrostatic compressive and tensile performance; and the torsional performance of the tubular structure.

The internal web may have a plurality of layers. The shell may have a plurality of layers. The layers of the internal web(s) and/or the layers of the shell may be laminated and/or bonded to one another.

A more specific aspect of the invention provides a tubular structure comprising an outer shell and at least one internal web, wherein each of the outer shell and the internal web is formed of a pair of laminated layers of fibre reinforced plastics material bonded to one another.

The tubular structure may comprise an inner shell, which may be joined to the outer shell by the at least one internal web. The inner shell may have a plurality of layers. The layers of the inner shell may be laminated and/or bonded to one another.

Bonding may be via an adhesive, heat fusing (e.g. welding), or via mixing of matrices of adjacent laminated layers. Bonding may be via co-consolidation. Bonding may be via co-moulding.

As such, dissimilar materials and/or fibre orientations may be used for different layers of the internal web and/or different layers of the outer shell and/or different layers of the inner shell. For example, a stiffer material may be used for the outer layer of the outer shell, where the stiffer material has the greatest effect on the bending stiffness of the tubular structure. Similarly, at least some of the fibres in one layer of one or each of the outer shell and the internal web(s) may be oriented in a first direction, while at least some of the fibres in another layer of one or each of the outer shell and the internal web(s) may be oriented in a second direction, e.g. different from the first direction. The second direction may, but need not, be substantially orthogonal to the first direction.

Thus, the mechanical performance of the tubular structure may be improved without increasing its weight.

The tubular structure may comprise and/or be formed by a plurality of tubes or sleeves, hereinafter “tubes”, but it will be appreciated that this term may be replaced with “sleeve”. It will be appreciated that “formed by” as used herein does not preclude the tubular structure also being formed by or including additional features or materials.

The tubes may, but need not, be circumferentially continuous, for example with no longitudinal join or bond. The tubes may be circumferentially continuous with no longitudinal join or bond along an outer surface of the tubular structure. The tubes may comprise an outer tube and one or more, e.g. a plurality of, inner tubes. At least one or each of the outer tube and/or the inner tube(s) may comprise a fibre reinforced plastics material. The inner tubes may be located inside the outer tube. The inner and outer tubes may be bonded together, e.g. such that they form the or a laminated outer shell and/or at least one laminated internal web and/or the inner shell.

At least one or each layer may comprise a textile or textile structure or fabric. At least one or each of the outer tube and/or the inner tube(s) may comprise a textile or textile structure or fabric. At least one or each of the layers or tube(s) may comprise a braid, weave or knit structure, e.g. a braided, woven or knitted fabric. At least one or each of the layers or tube(s) may comprise a braided structure in which the braids are formed by knitting or weaving. Additionally or alternatively, the fibres may be fused, bonded or suspended in or along or as a textile, braided, woven or knit structure within a plastics or polymer matrix.

Preferably, at least one or each of the layers or tubes is braided or comprises a braid or braided structure. At least one or each of the layers or tubes may comprise a braided fabric. The fibres may be braided. Additionally or alternatively, the fibres may be fused, bonded or suspended in or along or as a braided structure within a plastics or polymer matrix.

Advantageously, the geometry may be designed to suit the requirements of the tubular structure. For example, the inner tubes can be configured to provide the at least one internal web in a predetermined orientation, e.g. to provide the required mechanical performance.

The cross-section of the tubular structure may be segmented, for example by the internal web(s). The circumference or cross-sectional periphery of each of at least two of the inner tubes may be similar or substantially the same, e.g. such that the cross-section of the tubular structure is segmented into substantially equal parts. Thus, the internal web(s) may provide increased stiffness to the tubular structure, e.g. in the plane of the web(s).

A plurality of inner tubes may be located around a cavity in the centre of the tubular structure, e.g. such that the inner tubes are located between the cavity and the outer tube. Thus, a less critical or inactive portion of the webs at or adjacent the centre of the tubular structure may be removed. This may increase bending stiffness and/or increase the mechanical performance of the tubular structure when subjected to other loading conditions, such as torsional loading.

The inner tubes may comprise a central inner tube. The inner tubes may comprise one or more intermediate inner tubes, which may be around or located around the central inner tube and/or between the central inner tube and the outer tube. The central inner tube may be surrounded by one or more, e.g. a plurality of, intermediate inner tubes. The central inner tube and intermediate inner tube(s) may provide the or an inner shell, which may be joined to the outer shell by two or more webs. The central inner tube may describe the cavity.

The intermediate inner tube(s) may be bonded to the outer tube, e.g. such that they form the or a laminated outer shell. The intermediate inner tubes may be bonded together, e.g. such that they form the or at least one laminated internal web and/or the inner shell. The intermediate inner tube(s) may be bonded to the central inner tube, e.g. such that they form the or a laminated inner shell.

The inner shell may be substantially circular or polygonal in cross-section. The polygonal inner shell may comprise the same number of sides as the number of intermediate inner tubes, e.g. such that each internal web joins a corner of the polygonal shape to the outer shell. The polygonal inner shell may be triangular, rectangular (e.g. square), pentagonal, hexagonal, or have any number of sides.

One of the layers or inner or outer tubes may comprise a different material to another of the layers or inner or outer tubes. One of the layers or inner or outer tubes may comprise fibres oriented in a different direction to another of the inner or outer tubes. When the layers and/or tubes comprise a textile structure, the orientation of the structures may be misaligned, e.g. to provide some or all fibres of adjacent layers or tubes oriented in different directions.

The fibre reinforced plastics material may comprise fibres in a matrix. The fibres may comprise a first material and/or the matrix may comprise a second material. The first material may comprise an organic or synthetic polymer, glass or any combination thereof or any other suitable material. The fibres may comprise any combination of carbon fibres, glass fibres, polypropylene (PP) fibres, polyethylene (PE) fibres, aramid fibres, basalt fibres or any other reinforcement fibres. The second material may comprise a synthetic polymer, for example a thermoplastic polymer or a thermosetting polymer. The matrix may comprise a thermoplastic matrix or a thermosetting matrix. The matrix or second material may comprise Epoxy, Polypropylene (PP), Nylon (for example Polyamide (PA) Nylon including, but not limited to, PA6, PA12 or PA66), Polyethylene Terephthalate (PET), Polybutylene Terephthalate (PBT), Polyphenylene Sulfide (PPS), Polyether Ether Ketone (PEEK), Polyvinylidene Fluoride (PVDF), Polyetherimide (PEI).

The outer shell or its cross-section may comprise one or more curved portions or sides and/or one or more straight or flat portions or sides. The outer shell may be symmetrical or asymmetrical. The outer shell may comprise a curved or a polygonal cross-section. The curved cross-section may be substantially circular, elliptical, obround, ovoid or any other closed curve shape. The polygonal outer shell may be triangular, rectangular (e.g. square), pentagonal, hexagonal, or have any number of sides. The inner tubes may tesselate into a shape corresponding to the shape of the inside of the outer tube.

Another aspect of the invention provides a structural member, such as a beam, strut or piling, which comprises a tubular structure as described above.

Another aspect of the invention provides a method of manufacturing a tubular structure, e.g. a tubular structure as described above.

The tubular structure may comprise an impact resistant member. The inner shell may provide resistance to a tensile, compressive, and/or shear load. The outer shell may provide resistance to impact loads. The outer shell may protect the inner shell. The inner shell may comprise a greater number of axially aligned fibres than the outer shell. The outer shell may comprise a greater number of hoop-oriented fibres than the inner shell.

The tubular structure may comprise a tube, wherein the outer diameter of the tube may be greater than 10 times, 50 times or 100 times a wall thickness of the outer shell. The outer shell may comprise a greater number of hoop-oriented fibres than the inner shell in order to improve hoop rigidity. When the outer diameter of the tubular structure is large compared to the wall thickness of the outer shell, and so the tubular structure may be prone to radial buckling during loading, the greater number of hoop-orientated fibres in the outer shell may increase the buckling resistance. The resistance to radial buckling may be increased by aligning fibres in the radial direction in the inner shell. The one or more internal web(s) may be provided such that the plane of the internal web(s) is parallel to a bending direction of the large diameter tube. The one or more internal web(s) may be provided such that the plane of the internal web(s) is perpendicular to a bending direction of the large diameter tube and the internal web(s) may be offset from a central axis of the tubular structure, such that at least one of the internal web(s) is on a compression side of the tubular structure in bending. This may increase the compressive strength of the tubular structure, by adding more material on the compression side, in bending.

The tubular structure may comprise a piling. Inner tubes and/or internal webs may be provided in the tubular structure to increase the strength and/or stiffness of the piling.

The tubular structure may comprise an aerofoil. The tubular structure may have an outer contour shaped as an aerofoil. Spars of the aerofoil may be provided by internal webs. The outer surface of the aerofoil may be provided by the outer shell. This may enable the spars and the outer skin of the aerofoil to be formed at the same time, removing the need for any further assembly.

The method may comprise forming a tubular structure with an internal web comprising a fibre reinforced plastics material. The method may comprise forming the internal web with a plurality of layers. The method may comprise forming the internal web by laminating and/or bonding a plurality of layers together and/or to one another. The method may comprise forming a shell, e.g. an outer shell, within which the internal web is received and/or bonded. The method may comprise securing or bonding the internal web to an inner surface of the shell. The method may comprise forming the shell by laminating and/or bonding a plurality of layers together and/or to one another.

The method may comprising locating one or more, e.g. a plurality of, inner tubes within an outer tube. At least one or all of the inner and outer tubes may be unconsolidated and/or comprise unconsolidated fibres. At least one or all of the inner and outer tubes may be pre-consolidated and/or comprise pre-consolidated fibres. The method may comprise expanding the inner tube or each of the inner tubes within the outer tube, e.g. such the inner tubes are urged against one another and/or against the outer tube. The method may comprise bonding at least some of the outer and/or inner tubes together, e.g. to form an outer shell having a pair of laminated layers of fibre reinforced plastics material and/or to form at least one internal web with a pair of laminated layers of fibre reinforced plastics material. The method may comprise consolidating the fibres of at least some of the outer and/or inner tubes, e.g. within a matrix material.

The tubes may be bonded together as the inner tubes are expanded and/or immediately or shortly thereafter. This may reduce cycle time and/or manufacturing costs. This may also provide a more uniform structure, e.g. with less voids.

The method may comprise locating the or each inner tube around a bladder or a respective bladder. The method may comprise expanding, such as by inflating, the bladders, e.g. to expand the inner tubes within the outer tube such that adjacent parts of the inner and outer tubes are compressed together. The bladders may be configured to provide complex internal geometries, providing versatility in the design of the tubular structures, and/or may be expanded, e.g. inflated, to high pressures, for reducing voids between the inner and outer tubes. Expanding the bladders may comprise inflating the bladders using a fluid, for example a pressurised fluid. The fluid may comprise a pneumatic fluid, such as air, or a hydraulic fluid, such as oil.

The method may comprise inserting the outer tube into a mould tool, e.g. before expanding the inner tubes within the outer tube. The method may comprise expanding the inner tubes such that the outer tube is compressed against the mould tool.

The inner tubes and/or bladders may comprise or be of a similar or substantially the same size, e.g. such that the cross-section of the tubular structure is segmented into substantially equal parts.

The method may comprise locating a central inner tube over a central bladder or mandrel. When a central inner tube is used, the other inner tubes may comprise intermediate inner tubes. When a central bladder is used, the aforementioned bladders over which the intermediate inner tubes are located may comprise intermediate bladders.

The method may comprise locating the plurality of inner tubes within the outer tube, e.g. such that they are located between the central inner tube and the outer tube. The method may comprise expanding the plurality of intermediate inner tubes, e.g. such that adjacent parts of the intermediate inner tubes and the central inner tube are compressed together and/or such that the central inner tube is compressed against the central bladder or mandrel.

The method may comprise bonding the central and intermediate inner tubes together, e.g. to form an inner shell joined to the outer shell, for example by at least two internal webs. This may provide a reaction force to the expansion of the intermediate inner tubes, e.g. whilst maintaining the desired shape of the central inner tube.

The method may comprise melting or liquifying the matrix material to melt the matrix material and/or to cure the matrix material. The method may comprise introducing the matrix material in melted, molten or liquefied form into the fibres. Alternatively, the method may comprise introducing, e.g. pre-impregnating, the matrix material into the fibres prior to melting or liquifying it. The method may comprise cooling or solidifying the melted, molten or liquefied matrix material, e.g. to bond the layers or tubes together.

The method may comprise heating or melting a thermoplastic matrix material, e.g. to fuse the matrix material of adjacent layers or tubes together. The method may comprise cooling or solidifying the heated or melted thermoplastic matrix material, e.g. to bond the layers or tubes together.

Alternatively, the method may comprise liquifying, e.g. via heating, a thermoset material, for example to fuse the matrix material of adjacent layers or tubes together. The method may comprise curing or solidifying the liquified thermoset matrix material, e.g. to bond the layers or tubes together. The adjacent layers or tubes may be located about one or more mandrel(s) before curing or solidifying the liquified thermoset matrix material. The one or more mandrel(s) may provide the internal space(s) of the tubular structure. An external pressure may be applied to the layers or tubes to consolidate the layers or tubes. The layers or tubes may be formed around the mandrel(s) using vacuum pressure, e.g. using vacuum consolidation. The layers or tubes may be consolidated in an autoclave.

Heating may be by applying heat to the to the mould tool, for example using a heater or heating element such as a cartridge, band heater or heated fluid circulating through channels in the mould. Additionally or alternatively, heating may be applied to the bladders, e.g. using a heater or heating element and/or by expanding or inflating the bladders using a heated fluid. Cooling may be carried out using cooling fluid circulating through channels in the mould and/or filling the bladders with a cooling fluid.

The FRP material may comprise yarns with or including matrix material, e.g. matrix yarns, which may be interwoven with reinforcement fibres. The matrix material may comprise a plastics material. The yarns including matrix material may comprise matrix yarns or plastic yarns. The FRP material may comprise plastic yarns, which may be interwoven with reinforcement fibres. The plastic yarns may comprise thermoplastic yarns. The plastic yarns may comprise yarns formed of a thermoset material. the braided tube of fibres comprises yarns with matrix material.

The method may comprise providing at least one or each layer as a textile or textile structure or fabric. The method may comprise providing at least one or each of the outer tube and/or the inner tube(s) as a textile or textile structure or fabric. The method may comprise providing at least one or each layer or tube with a braid, weave or knit structure, e.g. a braided, woven or knitted fabric. The method may comprise providing the or each textile layer with matrix material pre-impregnated or infused therein. The method may comprise providing the or each textile layer with at least one, e.g. a plurality of, yarns comprising or being formed of the matrix material.

The method may comprise interlacing yarns to form the textile layer or tube. The interlacing step may be or comprise braiding, weaving or knitting. The method may comprise braiding, weaving or knitting yarns to form the textile layer or tube. The yarns may comprise fibres and matrix material. The yarns may comprise fibre yarns and/or matrix material yarns. The yarns may comprise at least one yarn which includes both fibres and matrix material.

The method may comprise curing, cooling or solidifying the matrix material such that the fibres are fused, bonded or suspended in or along or as a textile, braided, woven or knit structure within a plastics or polymer matrix.

Locating each of the inner tubes around the respective bladder may comprise interlacing, braiding, weaving or knitting each inner tube around a bladder, e.g. a respective bladder, for example whilst the bladder is partially inflated. Alternatively, locating each of the inner tubes around the respective bladder may comprise inserting each respective bladder into one of the inner tubes.

Locating the plurality of inner tubes within the outer tube may comprise interlacing, braiding, weaving or knitting the outer tube onto the inner tube(s) with a bladder or a respective bladder therein, e.g. whilst the bladders are partially expanded or inflated. Alternatively, locating the plurality of inner tubes within the outer tube may comprise inserting the inner tubes into the outer tube.

Locating the central inner tube over the central bladder or mandrel may comprise interlacing, braiding, weaving or knitting the fibre-reinforced plastic central tube onto the central bladder or mandrel. Alternatively, locating the central inner tube over the central bladder or mandrel may comprise inserting the mandrel into the central inner tube.

Another aspect of the invention provides a tubular structure obtainable using the method described above.

Another aspect of the invention provides a kit of parts for manufacturing a tubular structure, e.g. a tubular structure as described above and/or using a method as described above.

The kit may comprise an outer tube, which may be circumferentially continuous. The kit may comprise one or more, e.g. a plurality of, inner tube(s), which may be circumferentially continuous. The outer tube and/or the or each inner tube may comprise a fibre reinforced plastics material. The kit may comprise one or more, e.g. a plurality of, bladder(s), each of which may be for receipt within a respective one of the inner tubes. The kit may comprise a mould tool, which may define a cavity therein. The mould tool or cavity may be for receiving the outer tube and/or the inner tube(s). The kit may comprise a heating means or heater. The heating means or heater may be associated with, mounted to or incorporated in the mould tool and/or the bladders. The kit may comprise a central bladder or mandrel, which may be for receipt within a central one of the inner tubes.

Another aspect of the invention provides a computer program element comprising and/or describing and/or defining a three-dimensional design, e.g. of the tubular structure described above or an example thereof. The three-dimensional design may be for use with a simulation means or an additive or subtractive manufacturing means, system or device.

The computer program element may be for causing, or operable or configured to cause, an additive or subtractive manufacturing means, system or device to manufacture the tubular structure described above or an embodiment thereof. The computer program element may comprise computer readable program code means for causing an additive or subtractive manufacturing means, system or device to execute a procedure to manufacture the tubular structure described above or an example thereof.

A further aspect of the invention provides a computer program element comprising computer readable program code means for causing a processor to execute a procedure to implement one or more steps of the aforementioned method.

A yet further example provides the computer program element embodied on a computer readable medium.

A yet further example provides a computer readable medium having a program stored thereon, where the program is arranged to make a computer execute a procedure to implement one or more steps of the aforementioned method.

A yet further example provides a control means or control system or controller comprising the aforementioned computer program element or computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all example and/or features of any example can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The invention will now be described by way of example only with reference to the accompanying drawings, in which:

FIG. 1 is a section view of a tubular structure according to a first example, with a circular outer shell and a single internal web;

FIG. 2 is a section view of a tubular structure according to another example, with a circular outer shell and two internal webs;

FIG. 3 is a section view of a tubular structure according to yet another example, with a circular outer shell, a central internal web and intermediate internal webs;

FIG. 4 is a section view of a tubular structure according to yet another example, with a rectangular outer shell, a central internal web and intermediate internal webs;

FIG. 5 is a section view of a moulding apparatus for manufacturing the tubular structure of FIG. 1; and

FIG. 6 is a section view of a moulding apparatus for manufacturing the tubular structure of FIG. 3.

### DETAILED DESCRIPTION

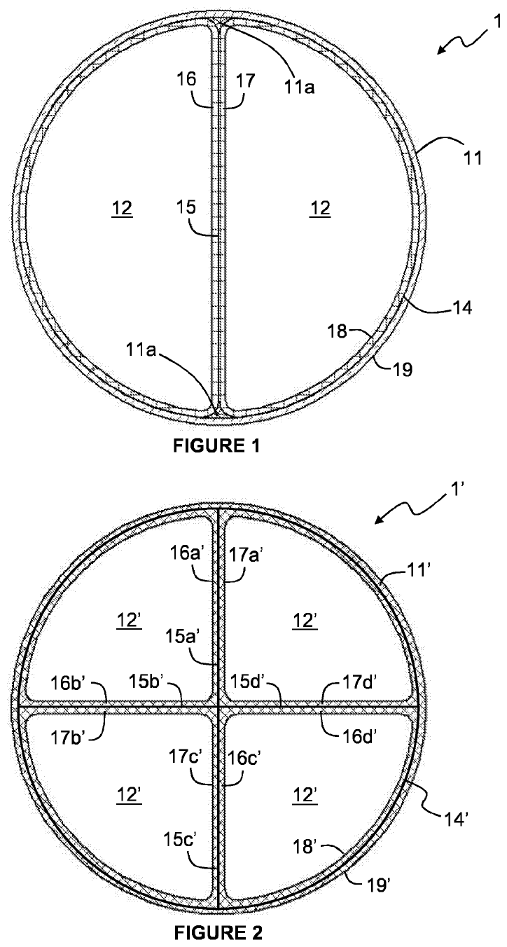

Referring to FIG. 1 there is shown a tubular structure 1, which includes an outer shell 14 with an internal web 15 extending between diametrically opposite sides. The tubular structure 1 is formed from an outer tube 11 and two inner tubes 12. In this example, the outer tube 11 and inner tubes 12 are bonded together, with each tube being consolidated to form a fibre-reinforced plastics (FRP) material.

The inner tubes 12 are located inside of the outer tube 11 and are bonded to one another and to the outer tube 11. In this example, the cross-sectional periphery of the outer tube 11 is circular and the cross-sectional periphery of each inner tube 12 is generally semi-circular, having a straight side and a curved side. The straight side corresponds to a flat face of each inner tube 12, and the curved side corresponds to a curved face of each inner tube 12.

The flat faces of the inner tubes 12 lie adjacent one another inside of the outer tube 11, and are bonded together to form the internal web 15. This provides the internal web 15 with a pair of laminated layers 16, 17 of FRP material bonded to one another. The curved faces of the inner tubes 12 are adjacent the outer tube 11, and are bonded to an internal face of the outer tube 11 to form an outer shell 14. In this way, the outer shell 14 is also formed of a pair of laminated layers 18, 19 of FRP material bonded to one another. In this example, the cross-sectional periphery of each inner tube 12 is substantially the same, so that the inner tubes 12 segment the tubular structure 1 into substantially equal parts.

The tubular structure 1 further comprises two fillet fillers 11a. The fillet fillers 11a are provided at the junctions between the two inner tubes 12 and the outer tube 11. The fillet fillers 11a fill voids which are created due to the minimum radii of the corners of the inner tubes 12. Due to the minimum radii of the corners, each inner tube 12 is not able to completely abut the other inner tube 12 and the outer tube 11. Therefore, this space is filled with a fillet filler 11. The fillet fillers 11a are elongated strips. The cross-sectional geometry of each fillet fillers 11a is configured to maximise the amount of the surface area of the fillet filler 11a that is in contact with material of the inner and outer tubes 11, 12. The fillet fillers 11a and are manufactured form any suitable material. The fillet fillers 11a may be metallic, plastic, or FRP. The fillet fillers 11a may be of the same, or similar material to the plastic in the FRP material. The fillet fillers 11a may be of the same material as the FRP material.

Whilst fillet fillers 11a are only shown in FIG. 1, they may be used to fill any void in any of the subsequent examples of tubular structures.

Referring now to FIG. 2, there is shown another example of a tubular structure 1′. The tubular structure 1′ of this example is similar to that of the previous example, wherein like references depict like features. The tubular structure 1′ according to this example differs in that there are four inner tubes 12′. The cross-sectional periphery of each inner tube 12′ has a shape which is a quadrant of a circle, having two straight sides and a curved side. The straight sides correspond to flat faces of the inner tube 12′, and the curved side corresponds to a curved face of the inner tube 12′.

Each flat face of an inner tube 12′ is bonded to an adjacent flat face of another inner tube 12′ to provide four internal webs 15a′, 15b′, 15c′, 15d′, joined at the centre of the tubular structure 1′, which are spaced at 90 degree intervals. The curved face of each inner tube 12′ is bonded to the internal face of the outer tube 11′ to provide the outer shell 14′. As with the previous example, the cross-sectional periphery of each inner tube 12′ is substantially the same, so that the inner tubes 12′ segment the tubular structure into substantially equal parts. As in the previous example, the aforementioned bonding of adjacent faces creates internal web 15a′, 15b′, 15c′, 15d′ having a respective pair of laminated layers 16a′, 17a′, 16b′, 17b′, 16c′, 17c′, 16d′, 17d′ of FRP material. Similarly, the outer shell 14′ also includes a pair of laminated layers 18′, 19′ of FRP material.

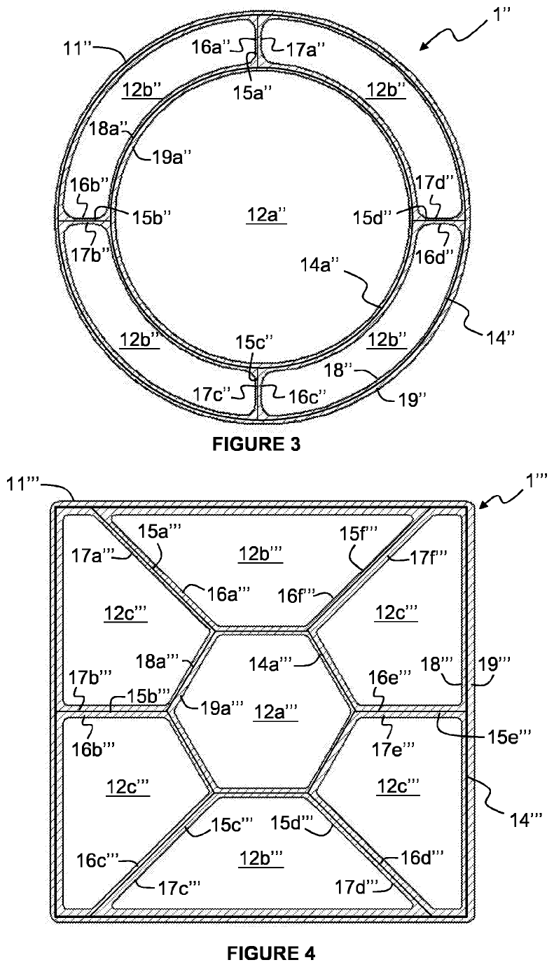

Referring now to FIG. 3, there is shown another example of a tubular structure 1″, which is similar to that of the previous example, wherein like references depict like features. The tubular structure 1″ in this example differs in that there are five inner tubes 12a″, 12b″ located inside of the outer tube 11″. One of the inner tubes is a central inner tube 12a″, which is substantially coaxial with the outer tube 11″. The remaining four inner tubes 12b″ are intermediate inner tubes 12b″, located between the central tube 12a″ and the outer tube 11″. The central inner tube 12a″ has a circular cross-sectional shape in this example. The cross-sectional periphery of each intermediate inner tube 12b″ is in the shape of a curved rounded rectangle, with two substantially concentric, curved sides and two substantially straight sides at either end of the curved sides. The curved sides correspond to curved faces of the intermediate inner tubes 12b″, and the straight sides correspond to flat faces of the intermediate inner tubes 12b″.

Each flat face of each intermediate inner tube 12b″ is bonded to an adjacent flat face of one of the other intermediate inner tubes 12b″, such that the intermediate inner tubes 12b″ together form an annular shape. The bonded flat faces of the intermediate tubes 12b″ also provide four intermediate internal webs 15a″, 15b″, 15c″, 15d″. One, innermost curved face of each intermediate inner tube 12b″ is located adjacent an outer surface of the central tube 12a″ and is bonded thereto, to provide an inner shell 14a″. The other, outermost curved face of each intermediate tube 12b″ is located adjacent the internal surface of the outer tube 11″ and is bonded thereto, to provide the outer shell 14″. As in the previous examples, the aforementioned bonding of adjacent faces provides each of the internal webs 15a″, 15b″, 15c″, 15d″ with a pair of laminated layers 16a″, 17a″, 16b″, 17b″, 16c″, 17c″, 16d″, 17d″ of FRP material. Similarly, the resulting outer shell 14″ has a pair of laminated layers 18″, 19″ of FRP material and the inner shell 14a″ has a pair of laminated layers 18a″, 19a″ of FRP material.

Referring now to FIG. 4, there is shown yet another example of a tubular structure 1′″ which is similar to that of the previous example, wherein like references depict like features. The tubular structure 1′″ in this example differs in that the shapes of the cross-sectional peripheries of the outer and inner tubes 11′″, 12a′″-12d′″ are different. In this example the cross-sectional periphery of the outer tube 11′″ is square, with four straight sides, which correspond to flat faces of the outer tube 11′″. The cross-sectional periphery of the central inner tube 12a′″ is hexagonal, with six sides of substantially equal length that correspond to six flat faces of the central inner tube 12a′″. The central inner tube 12a′″ is substantially coaxial with the outer tube 11′″ Two of the flat faces of the central inner tube 12a′″ are substantially parallel to two flat faces of the outer tube 11. Six intermediate inner tubes 12b′″, 12c′″ are incorporated in this example. Each intermediate inner tube 12b′″, 12c′″ has a cross-sectional periphery which is polygonal in shape, having multiple straight sides. Each straight side corresponds to a flat face of the intermediate inner tube 12b′″, 12c′″.

One flat face of each intermediate inner tube 12b′″, 12c′″ is located adjacent to a respective one of the flat faces of the central inner tube 12a′″, and is bonded thereto. This provides the inner shell 14a′″, having a pair of laminated layers 18a′″, 19a′″ of FRP material, similar to the example of FIG. 3. Two flat faces of each intermediate inner tube 12b′″, 12c′″ are located adjacent to flat faces of other intermediate inner tubes 12b′″, 12c′″ and are bonded thereto. This provides six intermediate internal webs 15a′″, 15b′″, 15c′″, 15d′″, 15e′″, 15f′″, each having a pair of laminated layers 16a′″, 17a′″, 16b′″, 17b′″, 16c′″, 17c′″, 16d′″, 17d′″, 16e′″, 17e′″, 16f′″, 17f′″ of FRP material, similar to the previous examples.

The remaining flat faces of each intermediate inner tube 12b′″, 12c′″ are located adjacent to an internal face of the outer tube 11′″ and bonded thereto. This arrangement provides the outer shell 14′″ with a pair of laminated layers 18′″, 19′″ of FRP material, similar to the previous examples. In this example the intermediate internal webs 15a′″, 15b″′, 15c′″, 15d′″, 15e′″, 15f′″ extend from the edges of the inner shell 14a′″, corresponding to the corners of the hexagonal shape of the cross-sectional periphery. The intermediate internal webs 15a′″, 15b′″, 15c′″, 15d′″, 15e′″, 15f′″ extend to the outer shell 14′″.

In this example the two intermediate inner tubes 12b″, which are located between the parallel faces of the central tube 12a′″ and the outer tube 11′″ have substantially the same cross-sectional peripheral shape as one another. The remaining intermediate inner tubes 12c′″ have substantially the same shape of cross-sectional periphery as one another except that two of the shapes are mirrors of the other shapes, providing mirrored pairs. These intermediate tubes 12c′″ are located adjacent to the faces of the central tube 12a′″ which are not parallel to the faces of the outer tube 11′″. The tubular structure 1′″ is substantially symmetrical about the planes intersecting the flat faces of the outer tube 11′″.

In all of the aforementioned examples, the FRP material of each of the inner and outer tubes 11, 12, 11′, 12′, 11″, 12a″, 12b″, 11′″, 12a′″, 12b′″, 12c′″ includes reinforcement fibres within a plastic matrix. The fibres and matrix of each may each be selected to suit the characteristics of the tubular structure 1, 1′, 1″, 1′″ required for the application. The matrix may comprise thermoset plastic or a thermoplastic. The fibres may comprise or be formed of an organic or synthetic polymer, glass or any combination thereof or any other suitable material. The fibres may comprise any combination of carbon fibres, glass fibres, polypropylene (PP) fibres, polyethylene (PE) fibres, aramid fibres, or any other reinforcement fibres.

In some examples, the inner tubes 12, 12′, 12a″, 12b″, 12a′″, 12b′″, 12c′″ each have the same matrix and fibre materials, which may be different from the outer tube 11, 11′, 11″, 11′″ has a different matrix and/or fibre material. In other examples, the central inner tube 12a″, 12a′″ has a different matrix and/or fibre material to the intermediate inner tubes 12b″, 12b′″, 12c′″ and to the outer tube 11″, 11′″. In yet further examples, the inner and outer tubes 11, 12, 11′, 12′, 11″, 12a″, 12b″, 11′″, 12a′″, 12b′″, 12c′″ all include the same matrix and/or fibre material. Other variations are also envisaged.

The tubular structure 1, 1′, 1″, 1′″ can be tailored to a specific application. By way of a specific example, the outer tube 11, 11′, 11″, 11′″ may comprise carbon fibres and each inner tube 12, 12′, 12a″, 12b″, 12a′″, 12b′″, 12c′″ may comprise glass fibres. In this case, the carbon fibre outer tube 11, 11′, 11″, 11′″ may provide strength and stiffness to the tube, whilst less expensive glass fibres may be used in the inner tubes 12, 12′, 12a″, 12b″, 12a′″, 12b′″, 12c′″.

The passageways formed by the inner tubes 12, 12′, 12a″, 12b″, 12a′″, 12b′″, 12c′″ of the tubular structure 1, 1′, 1″, 1′″ may be hollow. The inner tubes 12, 12′, 12a″, 12b″, 12a′″, 12b′″, 12c′″ of the tubular structure 1, 1′, 1″, 1′″ may serve as conduits, e.g. for fluid or cabling. Alternatively, the inner tubes 12, 12′, 12a″, 12b″, 12a″, 12b′″, 12c′″ may be filled, for example with a cellular material. The tubular structure 1, 1′, 1″, 1″′ is not limited to a particular use. Also, while specific shapes of the inner and outer tubes 11, 12, 11′, 12′, 11″, 12a″, 12b″, 11′″, 12a′″, 12b′″, 12c′″ have been described herein, it will be appreciated that any other shapes are envisaged, thereby providing further versatility to the design of the tubular structure 1, 1′, 1″, 1′″.

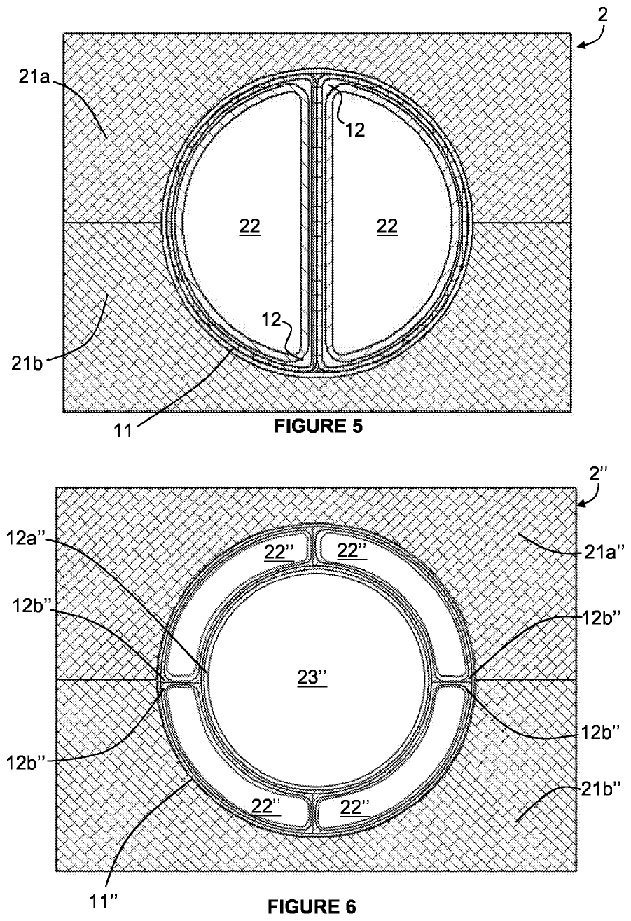

Referring now to FIG. 5, there is shown an example of a moulding apparatus 2 for manufacturing the tubular structure 1 of FIG. 1. The moulding apparatus 2 includes a mould tool 21, which has two mould halves 21a, 21b. When the mould halves 21a, 21b are in a closed configuration, they define a cavity therein which corresponds to the shape of an outer surface of the outer tube 11. In this example the cavity is circular in cross-section, but any suitable shape is envisaged, for example elliptical, polygonal, such as square or rectangular. The moulding apparatus 2 also comprises bladders 22 for location inside of the moulding cavity. In use, walls of the inner and outer tubes 11, 12 are located between each adjacent bladder 22, and between the bladders 22 and the mould halves 21a, 21b, to produce the tubular structure 1.

In order to manufacture the tubular structure 1 shown in FIG. 1, using the moulding apparatus 2, each inner tube 12 is located around a respective one of the bladders 22, the inner tubes 12 being unconsolidated, for example comprising unconsolidated reinforcement fibres and a matrix material. The inner tubes 12 and bladders 22 are then located adjacent to each other and the outer tube 11 is located over them so as to surround the inner tubes 12, the outer tube 11 also being unconsolidated. The inner tubes 12, bladders 22 and outer tube 11 are then inserted between the mould halves 21a, 21b, the mould halves 21a, 21b are brought together and secured or clamped together to resist separation.

With the two mould halves 21a, 21b secured together, the bladders 22 are expanded such that walls of the inner tubes 12 are compressed together, and the walls of the inner tubes 12 and the outer tube 11 are compressed together and against a surface of the cavity. A heating cycle is then applied to the moulding apparatus to consolidate the inner and outer tubes 11, 12 to form the tubular composite structure. Heat may be applied, for example using heaters (e.g. cartridge heaters) to the mould halves 21a, 21b, in order to heat the outer tube 11 and adjacent portions of the inner tubes 12. Heat may also be applied to the bladders 22, for example by expanding the bladders 22 using a heated fluid. The matrix material then melts or cures to bond the inner and outer tubes 11, 12 together. More particularly, the walls of the inner tubes 12 that are compressed together become bonded to form the internal web 15 and the walls of the inner tubes 12 that are compressed with the outer tube 11 become bonded to form the outer shell 14.

The tubular structure 1 is then removed from the mould tool 21, by opening the two mould halves 21a, 21b. The bladders 22 are deflated and removed from the tubular structure 1. The tubular structure 1 is removed from the mould 2. The bladders 22 may be removed before or after the tubular structure is removed from the mould tool 21.

The moulding apparatus 2 can also be used to manufacture the tubular structure 1′ shown in FIG. 2. The process is the same as that described for the tubular structure 1 of FIG. 1, except that four of the bladders 22 would be used, corresponding to the four inner tubes 12′. Adjacent walls of the four inner tubes 12′ would be bonded together to form the internal webs 15a′, 15b′, 15c′, 15d′. Walls of the inner tubes 12′ and the outer tube 11′ would be bonded together to form the outer shell 14′. As will be appreciated, any number of inner tubes 12, 12′ and respective bladders 22 may be used to provide a tubular structure with a required number of internal webs 15, 15a′, 15b′, 15c′, 15d′.

It will be appreciated by the skilled person that the aforementioned process is suitable for producing a tubular structure 1, 1′ comprising most types of FRP material. Furthermore, it will be appreciated that the aforementioned process may be used where the matrix is present in the unconsolidated inner and outer tubes 11, 11′, 12, 12′ before or after they are located around the bladders 22. In the former case the matrix may be a pre-impregnated resin, or thermoplastic material interspersed within the reinforcement fibres of the unconsolidated inner and outer tubes 11, 11′, 12, 12′. In the latter case a resin may be infused into the reinforcement fibres of the unconsolidated inner and outer tubes 11, 11′, 12, 12′ whilst they are in the mould.

In a specific example, the inner and outer tubes 11, 11′, 12, 12′ comprise a textile, for example they may comprise braided tubes 11, 11′, 12, 12′. Reinforcement fibres and plastic yarns, e.g. thermoplastic yarns, may be interlaced with one another, for example braided together. This may be carried out prior to locating the tubes around each of the bladders 22 to provide the unconsolidated inner tubes 22. Alternatively, the bladders 22 may be at least partially inflated and the fibres and yarns may be interlaced or braided thereon.

The inner tubes 12, 12′ and respective bladders 22 are then brought together in the desired configuration, and either inserted into an unconsolidated outer tube 11 or reinforcement fibres and thermoplastic yarns are interlaced or braided therearound, to provide the unconsolidated outer tube 11. The bladders 22, inner tubes 12 and outer tube 11 are then placed into the cavity, and the tubular structure 1, 1′ is manufactured as described above. During the heating cycle, the thermoplastic yarns are melted, thereby consolidating the inner and outer tubes 11, 11′, 12, 12′ to form the tubular structure 1, 1′. The consolidated tubular structure 1, 1′ may then be cooled to solidify the thermoplastic material.

It will be appreciated that the inner and outer tubes 11, 11′, 12, 12′ may comprise a woven or knit structure, or any other interlaced structure. The fibres and yarns may be woven or knit onto the bladders, instead of braided. The plastic yarns may comprise thermoset yarns and the heating cycle may comprise curing the thermoset material to consolidate the inner and outer tubes 11, 11′, 12, 12′.

Referring now to FIG. 6, another moulding apparatus 2″ is shown for manufacturing the tubular structure 1″ of FIG. 3. The moulding apparatus 2″ includes a mandrel 23″ for location in the centre of the cavity and bladders 22″ for location around the mandrel 23″, between the mandrel 23″ and the mould surface defining the cavity. In use, the walls of the inner and outer tubes 11″, 12a″, 12b″ are located between each adjacent bladder 22″, between the bladders 22″ and the surfaces of the cavity, and between the bladders 22″ and the mandrel 23″.

In order to manufacture the tubular structure 1″ shown in FIG. 3, using the moulding apparatus 2″ shown in FIG. 6, the central inner tube 12a″ is located around the mandrel 23″, either by inserting the mandrel 23″ into a premanufactured central inner tube 12a″ or by interlacing, such as by braiding, the central inner tube 12a″ over the mandrel 23″. Each intermediate inner tube 12b″ is located around a respective one of the bladders 22″, either by inserting the bladder 22″ into a premanufactured intermediate inner tube 12b″ or by interlacing, such as by braiding, the intermediate inner tube 12b″ over the bladder 22″. The inner tubes 12a″, 12b″ are unconsolidated when located around the mandrel 23″ and the bladders 22″.

The intermediate inner tubes 12b″, with the respective bladders 22″ therein, are then brought together around the central inner tube 12a″ and mandrel 23″ and the unconsolidated outer tube 11″ is located thereover. As in the previous example, this is either done by inserting the inner tubes 12a″, 12b″, mandrel 23″ and bladders 22″ into a premanufactured outer tube 11″ or by interlacing or braiding the outer tube 11″ over them. The outer and inner tubes 11″, 12a″, 12b″, bladders 22″ and mandrel 23″ are then located in the cavity and the mould halves 21a″, 21b″ brought together. With the two mould halves 21a″, 21b″ secured together, the bladders 22″ are inflated such that walls of the intermediate inner tubes 12a″ are compressed together. As a result, walls of the intermediate inner tubes 12b″ and the central inner tube 12a″ are compressed together and against a surface of the mandrel 23″, and walls of the intermediate inner tubes 12b″ and the outer tube 11″ are compressed together and against the surface of the cavity.

A heating cycle is then applied to the moulding apparatus to consolidate the inner and outer tubes 11″, 12a″, 12b″ into the tubular composite structure 1″. More specifically, the walls of the central and intermediate inner tubes 12a″, 12b″ that are compressed together are bonded to form the central internal shell 14a″. The walls of the intermediate inner tubes 12b″ that are compressed together are bonded to form the intermediate webs 15a″, 15b″, 15c″, 15d″. The walls of the intermediate inner tubes 12b″ and the outer tube 11″ that are compressed together are bonded to form the outer shell 14″.

In FIG. 6 the mandrel 23″ is depicted as being circular, but it will be appreciated that this could be of any shape. For example, the mandrel 23″ may be hexagonal in shape, the cavity may be square or rectangular in shape and six bladders 22″ may be employed, for example to produce the tubular structure 1′″ as shown in FIG. 4. The tubes 11″, 11′″, 12a″, 12b″, 12a′″, 12b′″, 12c′″ need not be braided. They may be woven, knit or interlaced in any other format.

It will be appreciated by those skilled in the art that several variations to the aforementioned examples are envisaged without departing from the scope of the invention. For example, the mandrel 23″ may be replaced with another bladder 22″, to provide the central inner tube 12a″, 12a′″. By way of another example, the mandrel 23 may be formed of, or replaced by, a material to which the central inner tube 12a″, 12a′″ is to be bonded. By way of another example, the central inner tube 12a may be omitted such that the intermediate inner tubes 12b are compressed between the respective bladder 22 and the mandrel 23.

It will also be appreciated by those skilled in the art that any number of combinations of the aforementioned features and/or those shown in the appended drawings provide clear advantages over the prior art and are therefore within the scope of the invention described herein.

1-25. (canceled)

26. A method of manufacturing a tubular structure, the method comprising:
locating a plurality of inner, circumferentially continuous braided tubes of fibre reinforced plastics material around a respective bladder;
locating an outer, circumferentially continuous braided tube of fibre reinforced plastics material onto the plurality of inner tubes;
expanding each of the bladders around which the inner tubes are located whilst the inner tubes are within the outer tube such the inner tubes are urged against one another and against the outer tube and adjacent parts of the inner and outer tubes are compressed together; and
bonding the outer and inner tubes together to form an outer shell having a pair of laminated layers of fibre reinforced plastics material and at least one internal web with a pair of laminated layers of fibre reinforced plastics material.

27. The method according to claim 26, wherein locating each of the inner tubes around the respective bladder comprises braiding each inner tube around a respective bladder whilst the bladder is partially inflated.

28. The method according to claim 27 wherein locating the plurality of inner tubes within the outer tube comprises braiding the outer tube onto the plurality of inner tubes with a respective bladder therein, whilst the bladders are partially inflated.

29. The method according to claim 26 comprising inserting the outer tube into a mould tool before expanding the inner tubes within the outer tube, such that the outer tube is compressed against the mould tool.

30. The method according to claim 26, wherein the inner tubes are of substantially the same size such that the cross-section of the tubular structure is segmented into substantially equal parts.

31. The method according to claim 26 comprising:
locating a central inner tube over a mandrel;
locating the plurality of intermediate inner tubes within the outer tube such that they are located between the central inner tube and the outer tube; and
expanding the plurality of intermediate inner tubes such that adjacent parts of the intermediate inner tubes and the central inner tube are compressed together and such that the central inner tube is compressed against the mandrel; and
bonding the central and intermediate inner tubes together to form an inner shell joined to the outer shell by at least two internal webs.

32. The method according to claim 31, wherein locating the central inner tube over the mandrel comprises braiding the central tube onto the mandrel.

33. The method according to claim 26, wherein the method comprises heating a thermoplastic material to bond the outer and inner tubes together.

34. The method according to claim 26, wherein the braided tube of fibres comprises yarns with matrix material.

35. The method according to claim 34, wherein the yarns of matrix material comprise thermoplastic yarns.

36. The method according to claim 26, wherein a plastic resin is pre-impregnated or infused into the tube(s) before the inner tubes are located within the outer tube and the plastic resin is heated or cured to bond the outer and inner tube together.

37. A system for manufacturing a tubular structure, the system comprising:
a plurality of inner circumferentially continuous braided tubes of fibre reinforced plastics material
a plurality of bladders for receipt within a respective one of the inner tubes;
an outer circumferentially continuous braided tube of fibre reinforced plastics material; and
a mould tool defining a cavity therein for receiving the outer tube and the inner tubes;
wherein the system is configured to expand, in use, the plurality of bladders when the inner tubes are located therearound whilst the inner tubes are within the outer tube and the outer tube is within the mould tool such the inner tubes are urged against one another and against the outer tube, the outer tube is compressed against the mould tool, adjacent parts of the inner and outer tubes are compressed together and the outer and inner tubes are bonded together to form an outer shell having a pair of laminated layers of fibre reinforced plastics material and at least one internal web with a pair of laminated layers of fibre reinforced plastics material.

38. The system according to claim 37 further comprising a heater or a source of heating fluid for heating the mould tool, wherein the fibre reinforced plastics material of at least one of the inner and outer tubes comprises yarns including thermoplastic matrix material interwoven with reinforcement fibres and the heater is operable to apply heat to the mould tool to heat or melt the thermoplastic matrix material to fuse the matrix material of adjacent tubes together.

39. The system according to claim 37 further comprising a source of heated fluid for supplying heated fluid to the bladders, wherein the fibre reinforced plastics material of at least one of the inner and outer tubes comprises yarns including thermoplastic matrix material interwoven with reinforcement fibres and the source of heated fluid is operable to supply heated fluid to the bladders to heat or melt the thermoplastic matrix material to fuse the matrix material of adjacent tubes together.

40. The system according to claim 37 further comprising a source of cooling fluid for circulating cooling fluid through channels in the mould tool.

41. The system according to claim 37 further comprising a source of cooling fluid for filling the bladders with cooling fluid.

42. A tubular structure formed by a plurality of circumferentially continuous braided tubes of fibre reinforced plastics material, the structure comprising an outer shell and at least one internal web, wherein the plurality of tubes are bonded together and comprise a plurality of inner braided tubes located inside an outer braided tube such that they form each of the outer shell and the internal web with a pair of laminated layers of fibre reinforced plastics material bonded to one another.

43. The tubular structure according to claim 42, wherein the cross-section of the tubular structure is segmented by the internal web(s).

44. The tubular structure according to claim 42, wherein one of the inner or outer tubes comprises a different material to another of the inner or outer tubes.

45. The tubular structure according to claim 42, wherein the plastics matrix comprises a thermoplastic matrix.
